(19) United States
(12) Patent Application Publication
(10) Pub. No.: US 2006/0266746 A1
(43) Pub. Date: Nov. 30, 2006

(54) PROTECTION MECHANISM FOR CONNECTORS

(76) Inventor: Zhao-Yu Wang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,454

(22) Filed: Dec. 29, 2005

(30) Foreign Application Priority Data
May 28, 2005 (CN) 200520059234.X

(51) Int. Cl. H02G 3/08

(52) U.S. Cl. 220/3.2

(57) ABSTRACT

A protection mechanism is provided for protecting connectors which are to be connected to electronic interfaces at a rear panel of a computer chassis. The protection mechanism includes a bracket secured to the rear panel, a first cover pivotally attached to the bracket for shielding the connectors, a second cover pivotally attached to the bracket, and a locking device. The first cover defines a plurality of slots for extension of cables of the connectors therethrough. The second cover is closed to abut against a side panel of the computer chassis to prevent the side panel from withdrawal. The locking device is so arranged between pivot ends of the first and second covers, that one of the first and second covers can be opened only when the other one is opened.

### CROSS-REFERENCES TO RELATED APPLICATION

Relevant subject matter is disclosed in the copending U.S. patent application Ser. No. 11/156,518, filed on Jun. 20, 2005, and entitled “PROTECTION DEVICE FOR CONNECTORS”; and the copending U.S. patent application filed on the same date and having a same title with the present application, which are assigned to the same assignee with this patent application.

1. Field of the Invention

The present invention relates to a protection mechanism for connectors connected to a computer.

2. Description of Related Art

Developments in networks and a great diversity of computer performances have resulted in more and more input/output interfaces disposed at a computer chassis. A typical computer chassis includes a plurality of connectors connected with cables. These cables include a power cable, a signal cable connecting a monitor, a mouse cable, a keyboard cable, a network cable, a microphone cord, and an earphone cord, etc. These cables are often in a mess at a rear panel of a computer, thereby resulting inconvenient during assembling or disassembling the computer.

In addition, the connectors at the rear panel are exposed in the air. Dust is often accumulated thereby affecting signal transfer. Furthermore, the connectors connected to the rear panel of the computer chassis are susceptible to being broken of or inadvertently disconnected because the connectors typically extend outwardly from the rear panel a substantial distance.

What is desired, therefore, is to provide a protection mechanism for protecting connectors of a computer from contamination or being damaged.

### SUMMARY OF INVENTION

In one preferred embodiment, a protection mechanism is provided for protecting connectors which are to be connected to electronic interfaces at a rear panel of a computer chassis. The protection mechanism includes a bracket secured to the rear panel, a first cover pivotally attached to the bracket for shielding the connectors, a second cover pivotally attached to the bracket, and a locking device. The first cover defines a plurality of slots for extension of cables of the connectors therethrough. The second cover is closed to abut against a side panel of the computer chassis to prevent the side panel from withdrawal. The locking device is so arranged between pivot ends of the first and second covers, that the second cover can be opened only when the first cover is opened.

The protection mechanism further includes a lock to lock the first cover to the bracket.

In this preferred embodiment, the side panel can be disassembled only when the second cover is opened, and the second cover can be opened only when the first cover is opened. Thus, only one lock can control the two covers and the side panel.

Other advantages and novel features will become more apparent from the following detailed description of preferred embodiments when taken in conjunction with the accompanying drawings, in which:

### BRIEF DESCRIPTION OF DRAWINGS

FIG. 1 is an isometric view of a protection mechanism in accordance with a preferred embodiment of the present invention, the protection mechanism being attached to a computer chassis, and including a bracket, a first cover, a second cover, two locking devices, and a lock;

FIG. 2 is an explosive, isometric view of the protection mechanism of FIG. 1;

FIG. 3 is similar to FIG. 2, but viewed from another aspect;

FIG. 4 is an assembled view of FIG. 3, showing a locked position;

FIG. 5 is an enlarged view of the encircled portion V of FIG. 4; and

FIG. 6 is similar to FIG. 5, but showing an unlocked position.

### DETAILED DESCRIPTION

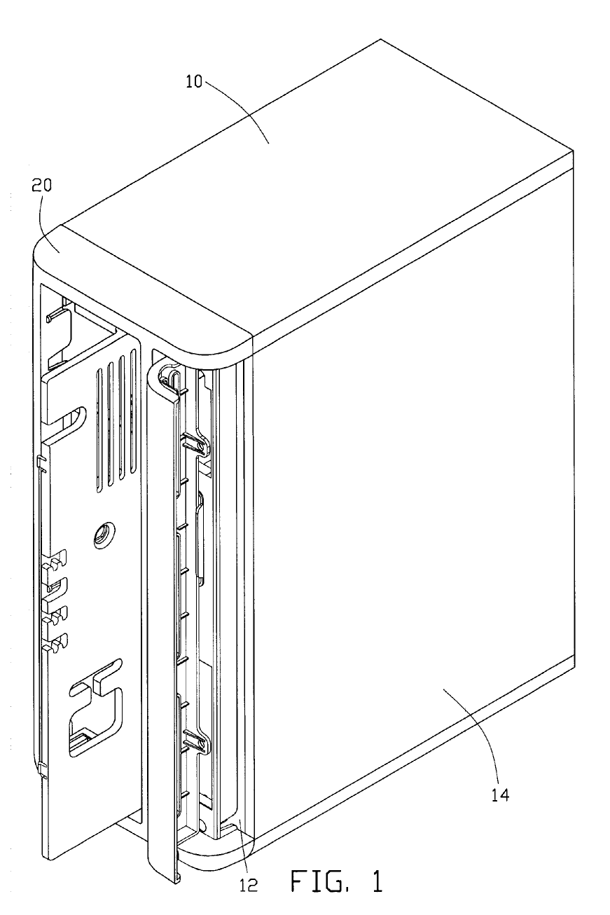

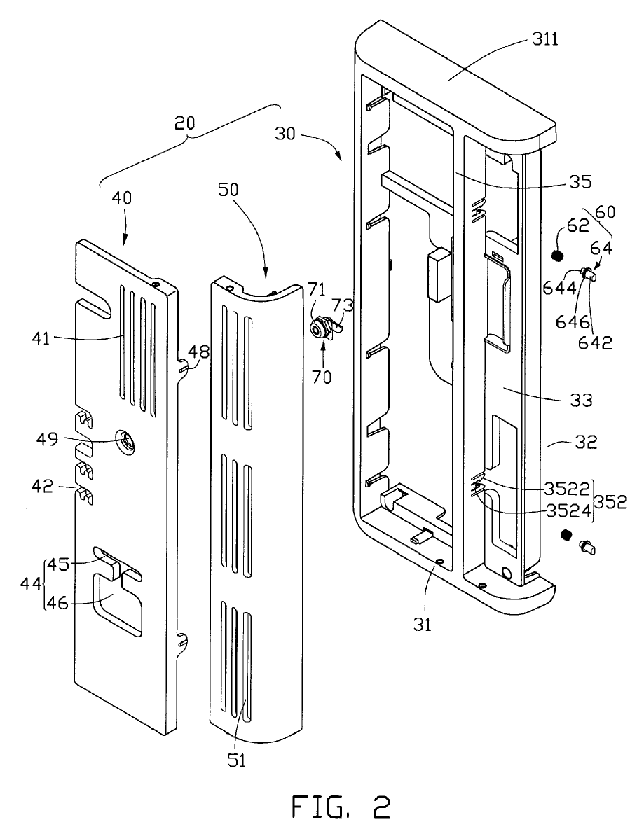

Referring to FIGS. 1-3, a protection mechanism 20 for connectors in accordance with a preferred embodiment of the present invention is to be attached to a rear portion of a computer chassis 10. The protection mechanism 20 includes a bracket 30, a first cover 40, a second cover 50, two locking devices 60, and a fastening device such as a lock 70. The computer chassis 10 includes a rear panel 12 for accommodating the connectors, and a side panel 14. The side panel 14 is slidably attached to the computer chassis 10 in a back-to-front direction. In another preferred embodiment, the side panel 14 is rotatably attached to the computer chassis 10 at a side near the rear panel 12. Each locking device 60 includes a resilient member and a latch 64. In this embodiment, the resilient member is a coil spring 62. The latch 64 includes a first pin portion 642, a second pin portion 644, and a flange 646 located between the first pin portion 642 and the second pin portion 644. The first pin portion 642 is a semicolumn.

The bracket 30 includes a U-shaped outer frame 31, and an inner frame 33. The outer frame 31 has a cutout 32 corresponding to the side panel 14 of the computer chassis 10. The outer frame 31 includes two arm portions 311, and a crossbeam 35 perpendicularly connecting the arm portions 311. The crossbeam 35 divides the outer frame 31 into two regions, one larger than the other. The first cover 40 is pivotally accommodated in the larger region, and the second cover 50 is pivotally accommodated in the smaller region. Pivot ends of the first and second covers 40, 50 are in the vicinity of the crossbeam 35. A cross section of the crossbeam 35 is U-shaped, and includes an opening facing the rear panel 12 and two side plates perpendicular to the rear panel 12. The crossbeam 35 includes two through holes 354 defined in one side plate adjacent the larger region, and two fastening portions 352 formed at the other side plate adjacent the smaller region. Each fastening portion 352 includes two opposite hooks 3522 and a post 3524 disposed between the hooks 3522. A receiving section is thereby defined between the hooks 3522 and the post 3524, for receiving the first pin portion 642 of the latch 64.

The inner frame 33 is recessedly formed between the arm portions 311 of the outer frame 31 for reinforcing the bracket 30. Four threaded holes 331 are defined in four corners of the inner frame 33, respectively. The bracket 30 is thereby secured to the rear panel 12 of the computer chassis 10 via screws. The inner frame 33 defines a plurality of openings in order not to shield the input/output interfaces. A locking portion 332 is formed at the inner frame 33 besides one of the openings.

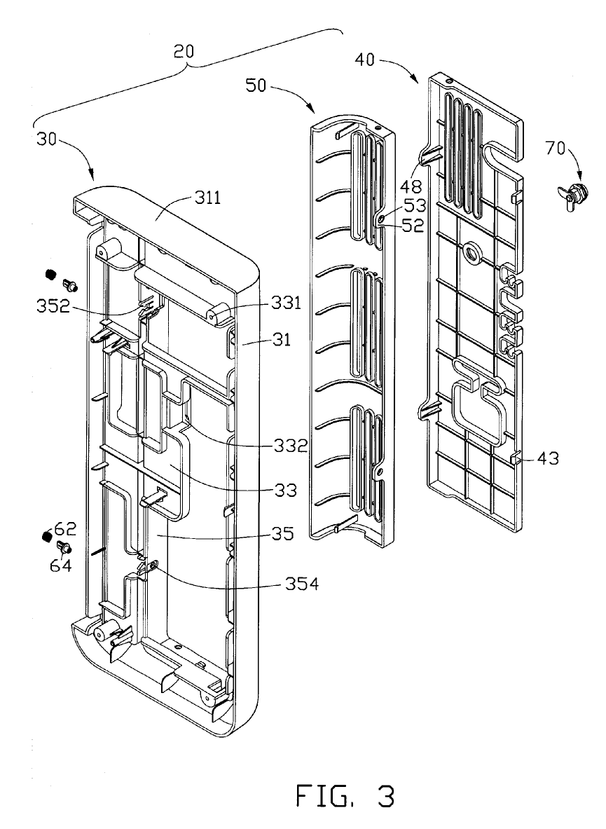

Referring also to FIG. 3, the first cover 40 is rectangular, and defines a plurality of ventilation holes 41 therein. One side away from a pivot end of the first cover 40 defines a plurality of through slots 42 for extension of cables of connectors therethrough, and forms two catches 43. The through slots 42 may be serration-shaped for accommodating multiple cables. The first cover 40 defines an opening 44 which includes a narrow accommodating slot 45, and a large assembly slot 46. A slim connecting slot communicates the accommodating slot 45 and the assembly slot 46. The accommodating slot 45 is located aligning with an expansion-slot zone which has input/output electronic interfaces such as expansion cards. The accommodating slot 45 collects cables of the connectors that are connected to the electronic interfaces. There may be more than one accommodating slot 45 communicating with each other. The assemble slot 46 is offset from the expansion card slots. The assemble slot 46 is set to be relatively large because a connector connected to an expansion card sometimes may be large. The accommodating slot 45 is set to be relatively narrow because the connector connected to the expansion card is not allowed to be unscrewed and pulled out through the accommodating slot 45. Thus, the connector and its cable are permitted to be pulled out only when the first cover 40 is rotated outwardly. Two blocking plates 48 extend perpendicularly from the first cover 40 at the pivot end thereof.

The second cover 50 is substantially arc-shaped, and defines a plurality of ventilation holes 51. Two lugs 52 perpendicularly extend from the pivot end of the second cover 50. A through aperture 53 is defined in each lug 52.

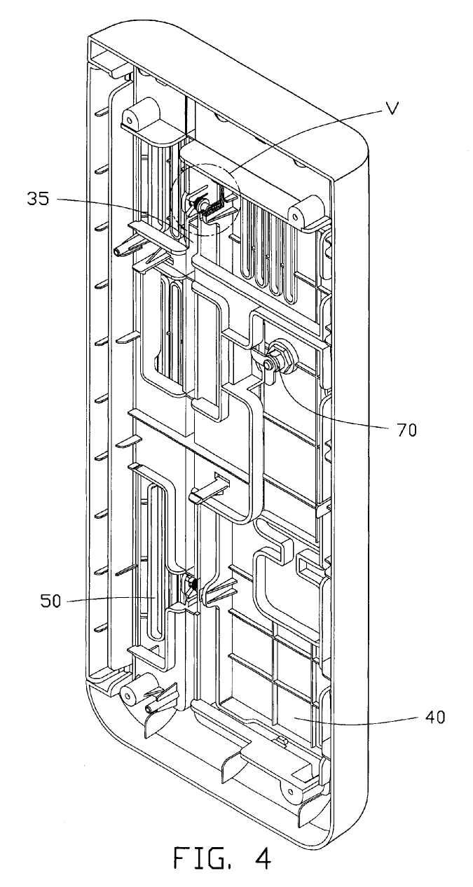

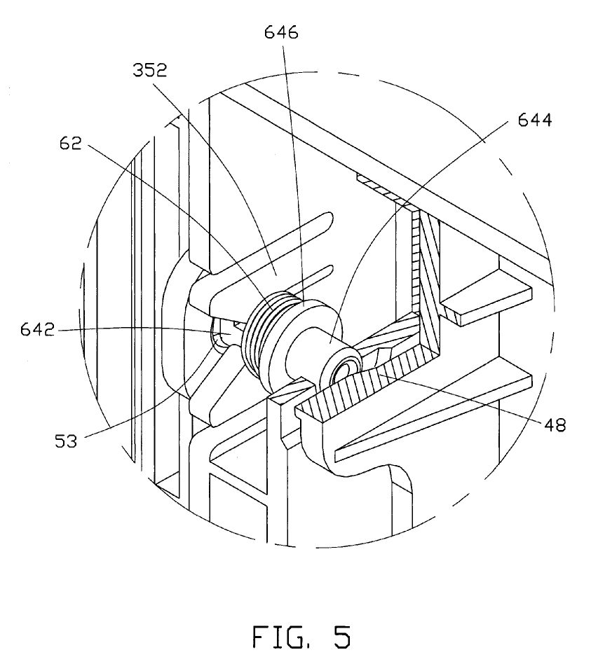

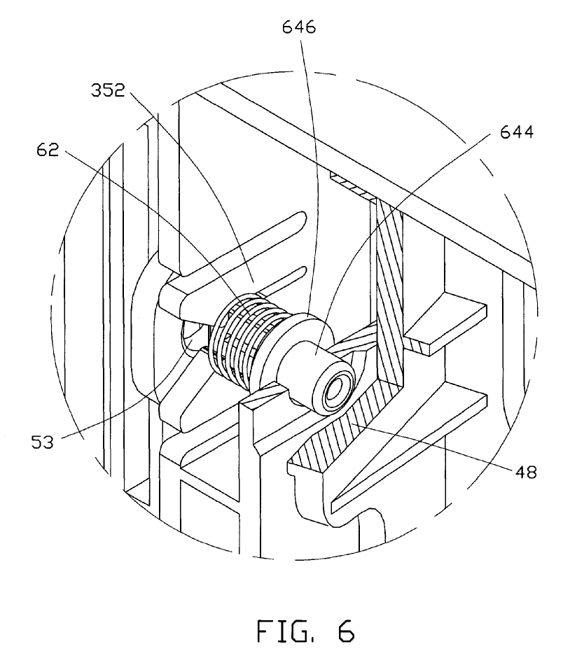

Referring also to FIGS. 4-6, the springs 62 are placed around the first pin portions 642 of the latch 64, respectively. Each spring 62 is compressed, so as to allow each latch 64 entering the crossbeam 35 from the opening. Meanwhile, the first pin portion 642 of each latch 64 squeezes into the receiving space of the fastening portion 352. The springs 62 are then released so as to urge the second pin portions 644 into the through holes 354 of the crossbeam 35. Thus, the latches 64 are capable of moving perpendicularly to/between the side plates of the crossbeam 35.

The first and second covers 40, 50 are respectively pivotally attached to the outer frame 31 at two opposite sides of the crossbeam 35. The second cover 50 is firstly closed, and the through apertures 53 of the second cover 50 are in alignment with the latches 64, respectively. After all connectors and their cables are extended through the first cover 40 to connect with the output/input interfaces of the rear panel 12 and the cables are collected in the accommodating slot 45, the first cover 40 is rotated into the larger region of the outer frame 30. Meanwhile, the blocking plates 48 push the latches 64, so that the first pin portions 642 enter the through apertures 53 of the second cover 50, respectively. The catches 43 of the first cover 40 engage with the outer frame 31 of the bracket 30.

The first cover 40 defines a lock hole 49 for accommodating the lock 70 or other locking means therein. The lock 70 as shown in FIG. 1 includes a lock core 71 and a lever 73. When the first cover 40 is closed, a key is inserted in the lock core 71 and drives the lever 73 to rotate. When the lever 73 is engaged with the locking portion 332, the first cover 40 is secured in a locked position. The second cover 50 is also secured in a locked position by the first cover 40. It will prevent an unauthorized person from plugging or pulling out connectors, or from stealing data from a computer.

When opening the second cover 50 is needed, the first cover 40 must be opened firstly. The lock 70 is screwed with a key to release the first cover 40. The first cover 40 is rotated outwardly so that the blocking plates 48 leave the latches 64. The latches 64 move toward the first cover 40 in the restoring force of the springs 62. The first pin portions 642 are thereby withdrawn from the through apertures 53. The second cover 50 is thus capable of being opened.

In this preferred embodiment, the second cover 50 is designed to be a separate part of the first cover 40, and rotated in a reverse direction of that of the first cover 40. This leaves the side panel 14 a withdrawal distance. If there is an integrated cover rotated at the side of the side panel 14, an undesired distance must be designed between the side panel and the cover for withdrawal of the side panel 14.

The second cover 50 can be opened only when the first cover 40 is opened. The side panel 14 can be disassembled only when the second cover 50 is opened. Thus, only one lock can control the two covers 40, 50 and the side panel 14.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. A protection mechanism for protecting connectors which are to be connected to electronic interfaces at a panel of a computer chassis, the protection mechanism comprising:
a bracket for being secured to the panel;
a first cover pivotally attached to the bracket for shielding the connectors, the first cover defining a plurality of slots for extension of cables of the connectors therethrough;
a second cover pivotally attached to the bracket, wherein the second cover is closed to abut against a side panel of the computer chassis to prevent the side panel from withdrawal; and
a locking device so arranged between pivot ends of the first and second covers, that one of the first and second covers can be opened only when the other one is opened.

2. The protection mechanism as claimed in claim 1, wherein the bracket is U-shaped, and comprises two arm portions, the pivot end of each of the first and second covers is pivotally connected to the arm portions.

3. The protection mechanism as claimed in claim 1, wherein the bracket comprises a crossbeam, the crossbeam has two side plates, the locking device is disposed between the side plates, and the first and second covers are respectively located at two opposite sides of the crossbeam.

4. The protection mechanism as claimed in claim 3, wherein the locking device comprises a latch and a resilient member.

5. The protection mechanism as claimed in claim 4, wherein the first cover comprises a blocking plate, the second cover comprises a through aperture, and wherein when the blocking plate presses one end of the latch, the other end of the latch enters the through hole, and when the blocking plate leaves the one end of the latch, the other end of the latch withdraws from the through hole.

6. The protection mechanism as claimed in claim 5, wherein the side plate of the crossbeam that beside the first cover defines a through hole, and the side plate of the crossbeam that beside the second cover forms a fastening portion; said one end of the latch extends through the through hole, and said other end of the latch is disposed in the fastening portion, the resilient member is placed around said other end of the latch.

7. The protection mechanism as claimed in claim 6, wherein the fastening portion comprises two opposite hooks and a post disposed between the hooks, a receiving section is thereby defined between the hooks and the post, for receiving said other end of the latch.

8. The portable computer as claimed in claim 1, further comprising a lock disposed in the first cover for locking the first cover to the bracket.

9. A protection mechanism comprising:
a bracket for being attached to a rear portion of a computer chassis;
a first cover and a second cover each pivotally attached to the bracket and rotated reversely, the first cover forming a blocking plate; and
a locking device comprising a latch;
wherein when the first cover is closed or open, the blocking plate of the first cover presses or leaves one end of the latch so that the other end of the latch is inserted into or withdrawn from the second cover.

10. The protection mechanism as claimed in claim 9, wherein the bracket comprises a crossbeam, the crossbeam comprises two opposite side plates, pivot ends of the first and second covers are respectively in the vicinity of the side plates.

11. The protection mechanism as claimed in claim 10, wherein the locking device is disposed between the side plates of the crossbeam, and movable in a direction perpendicular to the side plates.

12. The protection mechanism as claimed in claim 11, wherein the side plate of the crossbeam that besides the first cover defines a through hole, the side plate of the crossbeam that besides the second cover forms a fastening portion, said one end of the latch extends through the through hole, and said other end of the latch is disposed in the fastening portion.

13. The protection mechanism as claimed in claim 12, wherein the fastening portion comprises two opposite hooks, said other end of the latch is a semicolumn disposed between the hooks, a flange is formed between the two ends of the latch, a resilient member is arranged between the flange and the fastening portion.

14. The protection mechanism as claimed in claim 12, wherein the second cover forms a lug corresponding to the fastening portion, the lug defines a through aperture.

15. The protection mechanism as claimed in claim 9, further comprising a lock disposed in the first cover for locking the first cover to the bracket.

16. The protection mechanism as claimed in claim 9, wherein the first and second covers define a plurality of ventilation holes.
